(19) United States
(12) Patent Application Publication
(10) Pub. No.: US 2024/0373297 A1
(43) Pub. Date: Nov. 7, 2024

(54) ENABLING CONTINUATION OF VOICE SERVICES IN THE EVENT OF FAILURE OF SUBSCRIBER DATA LAYER IN A WIRELESS NETWORK

(71) Applicant: DISH Wireless L.L.C., Littleton, CO (US)

(72) Inventors: Dawood Shahdad, Aurora, CO (US); Xiangang Dai, Allen, TX (US)

(21) Appl. No.: 18/524,473

(22) Filed: Nov. 30, 2023

Related U.S. Application Data
(60) Provisional application No. 63/499,577, filed on May 2, 2023.

(51) Int. Cl. H04W 36/00; H04W 76/50

(52) U.S. Cl. CPC H04W 36/0022; H04W 76/50; H04W 36/0033

(57) ABSTRACT

Systems, methods, and non-transitory, machine-readable media facilitate continuation of voice services in the event of failure of a subscriber data layer in a wireless network. A cellular network core may include one or more servers. An emergency server may be configured to, during non-emergency operations of the cellular network core, collect subscriber mapping data. The subscriber mapping data may correspond to subscriber phone numbers and international mobile subscriber identities (IMSIs) for particular user equipment (UE). The emergency server may be further configured to, during non-emergency operations of the cellular network core, store the subscriber mapping data in storage, where the storage is not shared with the cellular network core. The emergency server may be further configured to, during an emergency mode, use a mapping of the subscriber phone numbers and/or the IMSIs for the particular UE to facilitate completion of one or more voice calls.

### CROSS REFERENCE TO RELATED APPLICATION

This application claims priority to U.S. Provisional Patent Application No. 63/499,577, filed on May 2, 2023, the disclosure of which is incorporated by reference in its entirety for all purposes.

### TECHNICAL FIELD

This disclosure generally relates to cellular network and particularly to enabling continuation of voice services in the event of failure of a subscriber data layer in a wireless network.

### BACKGROUND

Users use user equipment (UE) that communicates through a cellular network, relying on the cellular network to be available to provide service on a continuous basis. However, there is a potential for network disasters to happen, where multiple regions may fail such that geo-redundancy is insufficient to provide reliable service. Thus, there is a need for systems and methods that address such problems. This and other needs are addressed by the present disclosure.

### BRIEF SUMMARY

Certain embodiments may generally relate to cellular network and particularly to enabling continuation of voice services in the event of failure of a subscriber data layer in a wireless network.

In one aspect, a cellular network system to facilitate continuation of voice services in an event of a failure in a wireless network is disclosed. The cellular network may include one or a combination of the following. A cellular network core may include one or more servers. An emergency server may be configured to, during non-emergency operations of the cellular network core, collect subscriber mapping data. The subscriber mapping data may correspond to subscriber phone numbers and international mobile subscriber identities (IMSIs) for particular user equipment (UE). The emergency server may be further configured to, during non-emergency operations of the cellular network core, store the subscriber mapping data in storage, where the storage is not shared with the cellular network core. The emergency server may be further configured to, during an emergency mode, use a mapping of the subscriber phone numbers and/or the IMSIs for the particular UE to facilitate completion of one or more voice calls.

In another aspect, a method to facilitate continuation of voice services in an event of a failure in a wireless network is disclosed. The method may include one or a combination of the following. Operating of a cellular network core in a non-emergency mode may be facilitated. The cellular network may include one or more servers. During non-emergency operations of the cellular network core, subscriber mapping data may be collected by an emergency server. The subscriber mapping data may correspond to subscriber phone numbers and IMSIs for particular UE. During the non-emergency operations of the cellular network core, the subscriber mapping data may be stored by the emergency server in storage, where the storage is not shared with the cellular network core. During an emergency mode, a mapping of the subscriber phone numbers and/or the IMSIs for the particular UE may be used by the emergency server to facilitate completion of one or more voice calls.

In yet another aspect, one or more non-transitory, machine-readable media are disclosed as having machine-readable instructions thereon which, when executed by one or more processing devices, cause the one or more processing devices to perform operations to facilitate continuation of voice services in an event of a failure in a wireless network. The operations may include one or a combination of the following. Operating of a cellular network core in a non-emergency mode may be facilitated, where the cellular network may include one or more servers. During non-emergency operations of the cellular network core, subscriber mapping data may be collected by an emergency server. The subscriber mapping data may correspond to subscriber phone numbers and IMSIs for particular UE. During the non-emergency operations of the cellular network core, the subscriber mapping data may be stored by the emergency server in storage, where the storage is not shared with the cellular network core. During an emergency mode, mapping of the subscriber phone numbers and/or the IMSIs for the particular UE may be used, by the emergency server, to facilitate completion of one or more voice calls.

In various embodiments, the cellular network core may be configured to send subscriber data to the emergency server, where the subscriber data may correspond. to UE registrations during the non-emergency operations of the cellular network core. In various embodiments, the emergency server may be further configured to update the subscriber mapping data as subscriber changes are made. In various embodiments, the one or more servers may include a home subscriber server (HSS). In various embodiments, the emergency server may correspond to a standalone server that functions as an application server during normal operation mode and functions as a HSS during an emergency operation mode.

In various embodiments, the cellular network core may be configured to use the HSS during the non-emergency operations. In the emergency mode, the cellular network core may reconfigure to use the emergency server to obtain the subscriber mapping data, the subscriber phone numbers, and/or the IMSIs for the particular UE. The cellular network core may uses the subscriber mapping data, the subscriber phone numbers, and/or the IMSIs for the particular UE to complete the one or more voice calls. In various embodiments, the cellular network core may transition to the emergency mode when a database of the cellular network core is detected as having become corrupted.

In various embodiments, the cellular network core may correspond to an IP Multimedia Subsystem (IMS) core. In various embodiments, the IMS core may include a session border controller (SBC) and a call session control function (CSCF). In various embodiments, the IMS core may further include an application server (AS). In various embodiments, the emergency server may operate independently from the one or more servers. In various embodiments, the emergency server may be physically remote from the one or more servers.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a hybrid-cloud cellular network.

FIG. 2 illustrates an embodiment of a cellular network system that may correspond to an IP Multimedia Subsystem (IMS) or IP Multimedia Core Network Subsystem (IMS) network in a carrier.

FIG. 3 illustrates an embodiment of a cellular network system that may correspond to an IMS or IMS network in a carrier implementing a standalone emergency home subscriber server (HSS).

FIG. 4 illustrates an embodiment of a method 400 for registration call flow when the regular HSS is used.

FIG. 5 illustrates an embodiment of a method for registration call flow when the emergency HSS is used.

FIG. 6 illustrates an embodiment of a method for an in-network voice call when the emergency HSS is used.

### DETAILED DESCRIPTION

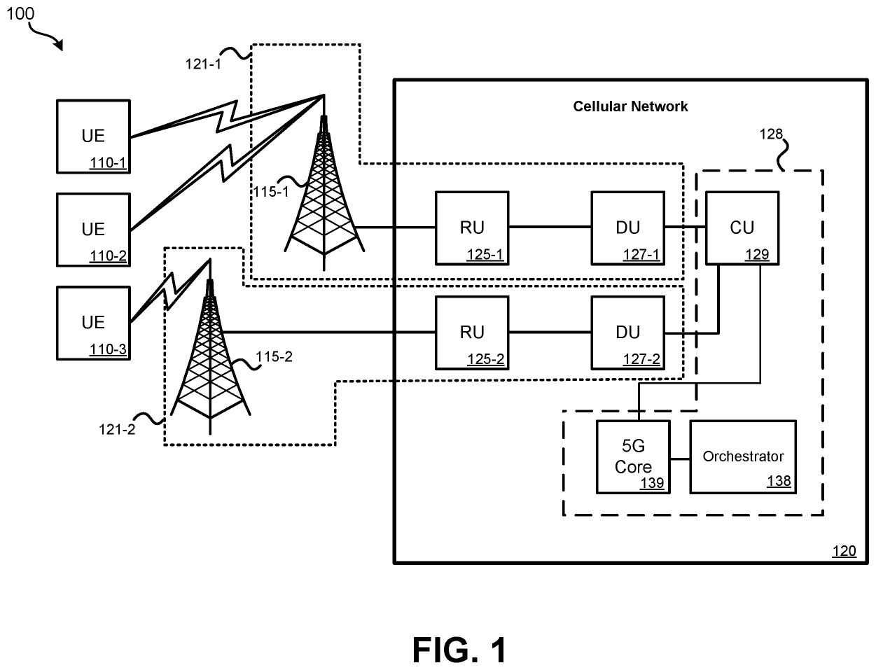

The implementations detailed herein may be implemented on a hardware-based cellular network. A hardware-based cellular network may use specialized or general-purpose computing hardware maintained directly by the cellular network provider to provide cellular services. Alternatively, implementations detailed herein may be performed on a hybrid-cloud cellular network, such as detailed in relation to FIG. 1.

FIG. 1 illustrates a block diagram of a hybrid cellular network system (“system 100”). Such a hybrid cellular network system is partially implemented using specialized hardware and partially implemented using virtualized cellular network components on a cloud-computing platform, such as Amazon Web Services (AWS). The system 100 may include a 5G New Radio (NR) cellular network; as noted, other types of cellular networks, such as 6G, 7G, etc., may also be possible. The system 100 may include: UE 110 (UE 110-1, UE 110-2, UE 110-3); structure 115; cellular network 120; radio units 125 (“RUs 125”); distributed units 127 (“DUs 127”); centralized unit 129 (“CU 129”); 5G core 139; and orchestrator 138. FIG. 1 represents a component-level view.

In a virtualized open radio access network (O-RAN), because components may be implemented as specialized software executed on general-purpose hardware, except for components that need to receive and transmit RF, the functionality of the various components may be executed by general-purpose servers. For at least some components, the hardware may be maintained by a separate cloud-service computing platform provider. Therefore, the cellular network operator may operate some hardware, such as base stations that include RUs and local computing resources on which DUs are executed, such components may be connected with a cloud-computing platform on which other cellular network functions (NFs), such as the cellular network core and higher-level RAN components, such as CUs, are executed.

The UE 110 may represent various types of end-user devices, such as cellular phones, smartphones, cellular modems, cellular-enabled computerized devices, sensor devices, robotic equipment, IoT devices, gaming devices, access points (APs), or any computerized device capable of communicating via a cellular network. More generally, UE may represent any type of device that has an incorporated 5G interface, such as a 5G modem. Examples may include sensor devices, Internet of Things (IoT) devices, manufacturing robots, unmanned aerial (or land-based) vehicles, network-connected vehicles, etc. Depending on the location of individual UEs, the UE 110 may use RF to communicate with various BSs of cellular network 120. As illustrated, two BSs are illustrated; BS 121-1 may include: structure 115-1, RU 125-1, and DU 127-1. The structure 115-1 may be any structure to which one or more antennas (not illustrated) of the BS are mounted. The structure 115-1 may be a dedicated cellular tower, a building, a water tower, or any other man-made or natural structure to which one or more antennas may reasonably be mounted to provide cellular coverage to a geographic area. Similarly, BS 121-2 may include: structure 115-2, RU 125-2, and DU 127-2.

Real-world implementations of system 100 may include many (e.g., thousands) of BSs and many CUs and 5G core 139. BS 121-1 may include one or more antennas that allow RUs 125 to communicate wirelessly with UEs 110. RUs 125 may represent an edge of cellular network 120 where data is transitioned to RF for wireless communication. The radio access technology (RAT) used by RU 125 may be 5G NR, or some other RAT. The remainder of cellular network 120 may be based on an exclusive 5G architecture, a hybrid 4G/5G architecture, or some other cellular network architecture that supports cellular network slices. The BS 121 may include an RU (e.g., RU 125-1) and a DU (e.g., DU 127-1).

One or more RUs, such as RU 125-1, may communicate with DU 127-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, band 71. In some embodiments, an RU may also operate on three bands.

One or more DUs, such as DU 127-1, may communicate with CU 129. Collectively, an RU, DU, and CU create a gNodeB, which serves as the radio access network (RAN) of cellular network 120. DUs 127 and CU 129 may communicate with 5G core 139. The specific architecture of cellular network 120 may vary by embodiment. Edge cloud server systems (not illustrated) outside of cellular network 120 may communicate, either directly, via the Internet, or via some other network, with components of cellular network 120. For example, DU 127-1 may be able to communicate with an edge cloud server system without routing data through CU 129 or 5G core 139. Other DUs may or may not have this capability.

While FIG. 1 illustrates various components of the cellular network 120, other embodiments of the cellular network 120 may vary the arrangement, communication paths, and specific components of the cellular network 120. While the RU 125 may include specialized radio access componentry to enable wireless communication with the UE 110, other components of the cellular network 120 may be implemented using either specialized hardware, specialized firmware, and/or specialized software executed on a general-purpose server system. In a virtualized arrangement, specialized software on general-purpose hardware may be used to perform the functions of components such as the DU 127, the CU 129, and the 5G core 139. Functionality of such components may be co-located or located at disparate physical server systems. For example, certain components of the 5G core 139 may be co-located with components of the CU 129.

In a possible virtualized implementation, the CU 129, the 5G core 139, and/or the orchestrator 138 may be implemented virtually as software being executed by general-purpose computing equipment on a cloud-computing platform 128, as detailed herein. Therefore, depending on needs, the functionality of a CU, and/or 5G core may be implemented locally to each other and/or specific functions of any given component may be performed by physically separated server systems (e.g., at different server farms). For example, some functions of a CU may be located at a same server facility as where the 5G core 139 is executed, while other functions are executed at a separate server system or on a separate cloud computing system. In the illustrated embodiment of the system 100, the cloud-computing platform 128 may execute the CU 129, the 5G core 139, and the orchestrator 138. The cloud-computing platform 128 may be a third-party cloud-based computing platform or a cloud-based computing platform operated by the same entity that operates the RAN. The cloud-based computing platform 128 may have the ability to devote additional hardware resources to cloud-based cellular network components or implement additional instances of such components when requested.

Kubernetes, Docker®, or some other container orchestration platform, may be used to create and destroy the logical CU or 5G core units and subunits as needed for the cellular network 120 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. Rather, processing and storage capabilities of the data center would be devoted to the needed functions. When the need for the logical CU or subcomponents of the CU no longer exists, Kubernetes may allow for removal of the logical CU. Kubernetes may also be used to control the flow of data (e.g., messages) and inject a flow of data to various components. This arrangement may allow for the modification of nominal behavior of various layers. The deployment, scaling, and management of such virtualized components may be managed by the orchestrator 138. The orchestrator 138 may represent various software processes executed by underlying computer hardware. The orchestrator 138 may monitor the cellular network 120 and determine the amount and location at which cellular network functions should be deployed to meet or attempt to meet service level agreements (SLAs) across slices of the cellular network.

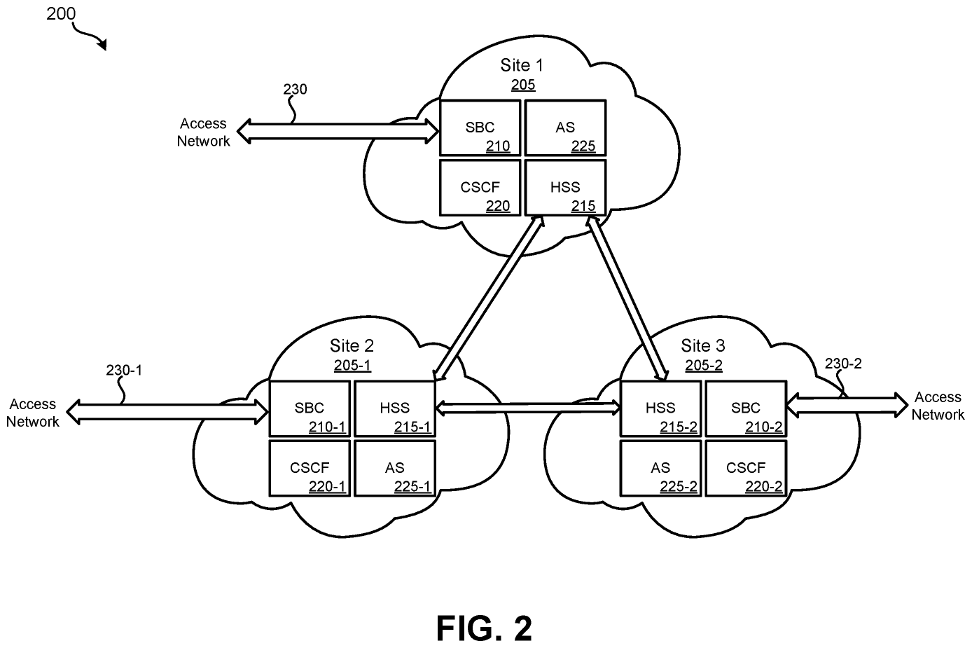

FIG. 2 illustrates an embodiment of a cellular network system 200 (“system 200”) that may correspond to an IP Multimedia Subsystem (IMS) or IP Multimedia Core Network Subsystem (IMS) network in a carrier. The system 200 may correspond to a typical IMS network in a carrier. As illustrated, a typical IMS deployment may provide for geo-redundancy. Multiple IMS networks may be deployed at different sites 205. Thus, the system 200 may include a plurality of sites 205 in different regions.

Each site 205 may include a call session control function (CSCF) 220. The CSCF 220 may be provided by one or more servers (e.g., session initiation protocol (SIP) servers or proxies). For example, an Interrogating-CSCF (ICSCF), a Serving-CSCF (SCSCF), and/or the like may provide registrar and call routing functions, among others. Each site 205 may include an application server (AS) 225. The ASs 225 may provide services, such as telephony application server (TAS) providing telephony services. Each site 205 may further include a home subscriber server (HSS) 215. The HSS 215 may provide subscription information, registrar information, and authentication information, among others. Each site 205 may further include a session border controller (SBC) 210. The SBC 210 may correspond to an edge node for IMS network access 230. Each site 205 may further include other supporting nodes not shown, such as a media resource function (MRF) and/or the like.

As part of providing geo-redundancy, the CSCFs 220 and the ASs 225 may run independently in each site 205. Although the system 200 may have multiple HSSs 215 in different sites 205, all the HSSs 215 may share a distributed database such that it is effectively a common geo-redundant subscriber database in multiple diverse regions. The sharing of a distributed database by all HSSs 215 may cause problems. Though an HSS 215 may be accessed from multiple sites 205 due to geo-redundancy, the database sharing effectively makes all HSSs 215 one single node. If the database is corrupted due to any reason, such as network issues, software bugs, security breaches, etc., all HSSs 215 may be impacted, effectively causing the HSSs 215, with all the authentication and subscription data, to not be workable across the network. Consequently, users would not be able to register and access IMS services, such as voice calls. Such a database problem has occurred multiples times in major carriers around the world, resulting in customers not being able to make and receive calls for many hours. Disclosed embodiments provide a solution to such problems.

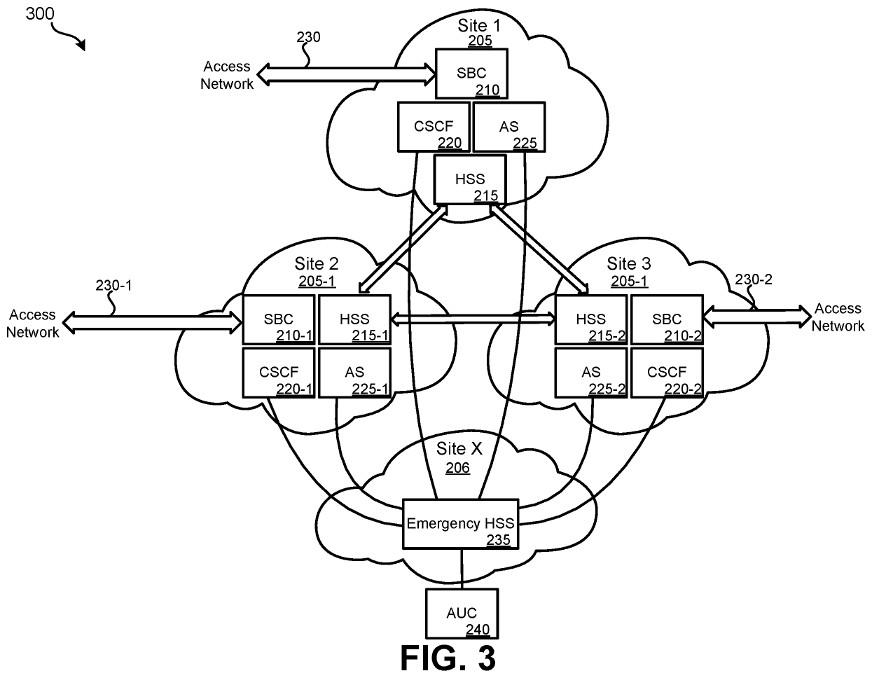

FIG. 3 illustrates an embodiment of a cellular network system 300 (“system 300”) that may correspond to an IMS or IMS network in a carrier implementing a standalone emergency HSS 235, in accordance with embodiments according to the present disclosure. The system 300 may provide for network disaster prevention with the implementation of the emergency HSS 235. This may include the system 300 providing for voice network disaster prevention with the implementation of the emergency HSS 235 over a public cloud in a manner that is 3GPP compliant. When the subscriber data layer (SDL) goes down or degrades to a particular threshold, the system 300 may transition to an emergency mode, which may include bypassing authentication and encryption.

The system 300 may include a site 206 with the emergency HSS 235. In some embodiments, the site 206 may be physically remote from, and not co-located with, other sites 206. The emergency HSS 235 may be completely independent from normal HSSs 215, not sharing resources, sites, physical locations, database access, and/or the like with the normal HSSs 215. When regular HSSs 215 are not accessible, the standby emergency HSS 235 is required to continue to provide voice and messaging services. The HSS 235 may provide registration services, including services to locate a SCSCF 220 for registrar and provide an authentication vector. The HSS 235 may store the UE mobile subscriber ISDN number (MSISDN) (or another external identifier that is globally unique for a particular UE) and the anchoring SCSCF for terminating service. The HSS 235 may provide subscriber profiles to the SCSCF 220 for call routing and subscriber data to ASs 225 for call services.

The emergency HSS 235 may be provided for the whole network. During normal operations (e.g., non-emergency operations), SCSCFs 220 and ASs 225 may only use regular HSSs 215. When a network disaster occurs (e.g., an HSS-caused disaster), the system 300 may manually or automatically switch to use the emergency HSS 235 via methods like domain name system (DNS) address reconfiguration, local address reconfiguration, and/or the like. An emergency situation may be detected based at least in part on automatic or manual detection of instances of call failures satisfying a threshold number of call failures over a particular time window and/or a threshold rate of call failures per unit of time occurring at one, more, or all sites 205 in various embodiments. Such call failures may include failed attempts to fetch UE locations and/or identifiers from HSSs 215. Accordingly, when HSS 215 performance is determined to be degraded enough, the system 300 may transition to an emergency operational mode.

When the disaster-recovery mode is activated, standard call flows may be bypassed, and additional operations may be performed to get the necessary identifier data and complete calls. To facilitate the transition, the CSCFs 220 may, for example, be reconfigured with the emergency HSS 235 address, enabling communication between the CSCFs 220 and the emergency HSS 235. When an emergency happens, the address reconfiguration may be performed manually or automatically via either causing a reconfiguration of the DNS mapping to replace addresses of the HSS 215 with the address of the emergency HSS 235 or, if the CSCFs 220 are local configured, locally changing the configuration of HSS 215 address to the emergency HSS 235 address in order to communicate with the emergency HSS 235. Likewise, to transition back to normal operations when one or more of the HSSs 215 are back online with indicia of sufficient performance (e.g., satisfying one or more performance thresholds, such as not meeting or exceeding a threshold number of call failures over a particular time window and/or a threshold rate of call failures per unit of time during testing or trial periods), the addresses of the CSCFs 220 may again be manually or automatically reconfigured with the addresses of the one or more HSSs 215 in like manner.

The emergency HSS 235 may be provisioned with the necessary UE registration information to determine which UE is registered in which service area. During normal operations, when UE registration is performed with respect to the call network, registration communications may be communicated to the SCSCF 220, and the SCSCF 220 may send corresponding communications toward the HSS 215. To facilitate emergency operations, the SCSCF 220 may send normal parameter messages to the normal HSS 215 for registration and, at the same time, also send third-party registration messages toward the emergency HSS 235 so the HSS 235 will also have information on the UE registered. The SCSCF 220 may treat the emergency HSS 235 as an application server, indicating which particular UE is currently registered in which particular service area/CSCF 220. Such operations may be performed every time a UE registers. From the CSCF 220 perspective, the emergency HSS 235 may be a normal application server with a standard application server interface.

In some embodiments, the emergency HSS 235 may be provisioned as an application server in a UE's service profile. With this provisioning, in normal operation, the SCSCF 220 may send third-party register communications to the emergency HSS 235, and the emergency HSS 235 may record the UE's MSISDN and the anchoring SCSCF 220 for terminating call service. Additionally or alternatively to provisioning the emergency HSS 235 as an application server in the UE service profile, Cx and/or Sh traffic from all regular HSSs 215 may be mirrored to the emergency HSS 235 so that the emergency HSS 235 may extract UE MSISDNs and anchoring SCSCFs 220 for the terminating service.

During emergency operational modes, the emergency HSS 235 may provide Cx and Sh interfaces for CSCFs 220 and ASs 225. The emergency HSS 235 may be locally configured with a service profile that is applicable for all users, except for the SCSCF 220 capability. The emergency HSS 235 may configure UE SCSCF 220 capability to evenly distribute UEs across all SCSCFs 220, for example, based on UE MSISDN.

The site 206 and the emergency HSS 235 may store subscriber profile data to the extent necessary information to perform emergency recovery. Such information may include the international mobile subscriber identity (IMSI) for particular UE to be involved in a session. In order to make voice calls, a subscriber number is necessary, and the network gets IMSI which is a different identity typically contained within the SDL. Thus, the emergency HSS 235 may obtain subscriber mapping data and constantly keep it updated as subscriber changes are made.

In various embodiments, in the emergency mode, the system 300 (e.g., the IMS core) reconfigures to use the emergency server to obtain from the emergency HSS 235 the subscriber mapping data, the subscriber phone numbers, and/or the IMSIs for particular UE and use the subscriber mapping data, the subscriber phone numbers, and/or the IMSIs for the particular UE to complete voice calls. For example, when the SDL is non-functional, the system 300 may use a mapping of subscriber phone numbers and IMSIs stored by the emergency HSS 235 in a database of the emergency HSS 235, which may allow lookup to complete calls during emergency operations. Emergency mode call flows may, for example, dip into the database, identify an IMSI, and then translate that to a phone number.

The system 300 may provide limited functionality during an emergency. The system 300, with the emergency HSS 235, may, for example, allow the voice services to make voice calls and access basic network services but may limit one or more of conference calling, multiparty voice, and/or complicated services. The system 300 may disable authentication when the emergency HSS 235 is used. Alternatively, the emergency HSS 235 may connect with an authentication center (AUC) 240 to generate authentication vectors. Either mode may be configured as a default in various embodiments.

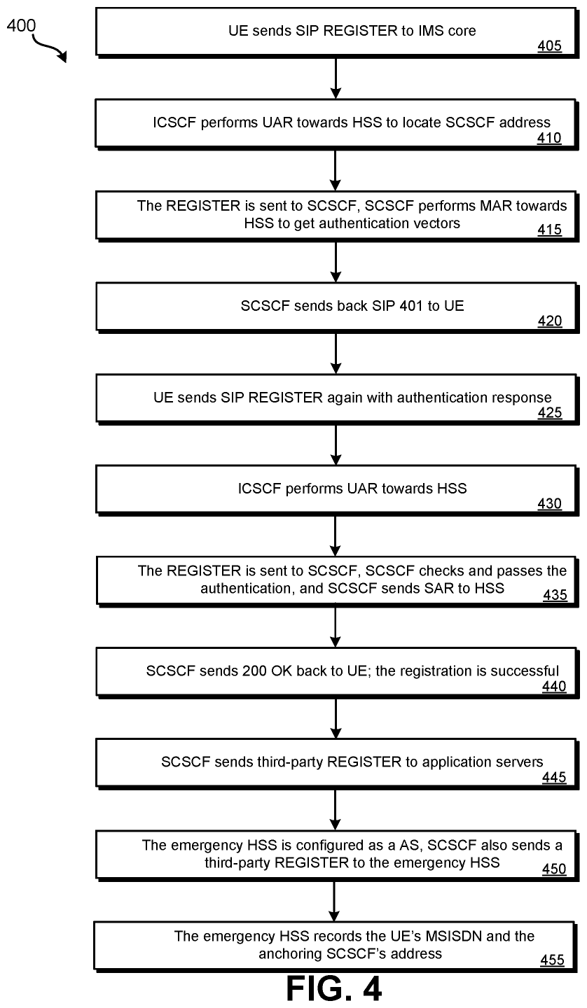

Various methods may be performed using the system 300. FIG. 4 illustrates an embodiment of a method 400 for registration call flow when the HSS 215 is used, in accordance with embodiments according to the present disclosure. As indicated by block 405, UE may communicate with the IMS core. For example, a UE may communicate 230-1 with the SBC 210-1 of the site 205-1. The communications 203-1 may include the UE sending a SIP REGISTER communication to the SBC 210.

As indicated by block 410, the ICSCF 220 may perform a diameter user-authorization-request (UAR) and send a UAR message towards the HSS 215 to location the SCSCF 220 address. As indicated by block 415, the REGISTER message may be sent to the SCSCF 220, and the SCSCF may perform multimedia-auth-request (MAR) and send an MAR message towards the HSS 215 to get authentication vectors. As indicated by block 420, the SCSCF 220 may send back a SIP 401 message the UE.

As indicated by block 425, the UE may send a SIP REGISTER message again with an authentication response. As indicated by block 430, the ICSCF 220 may perform UAR towards the HSS 215. As indicated by block 435, the REGISTER message may be sent to the SCSCF 220. The SCSCF 220 may check and pass the authentication. The SCSCF 220 may send a diameter server-assignment-request (SAR) message to the HSS 215. As indicated by block 440, the SCSCF 215 may send a SIP 200 (OK) response back to the UE, and the registration may be successful.

As indicated by block 445, the SCSCF 220 may send a third-party REGISTER message to the AS 225. As indicated by block 450, the emergency HSS 235 may be configured as an application server, so the SCSCF 220 may also send a third-party REGISTER message to the emergency HSS 235. As indicated by block 455, the emergency HSS 235 may record the UE's MSISDN and the anchoring SCSCF's address.

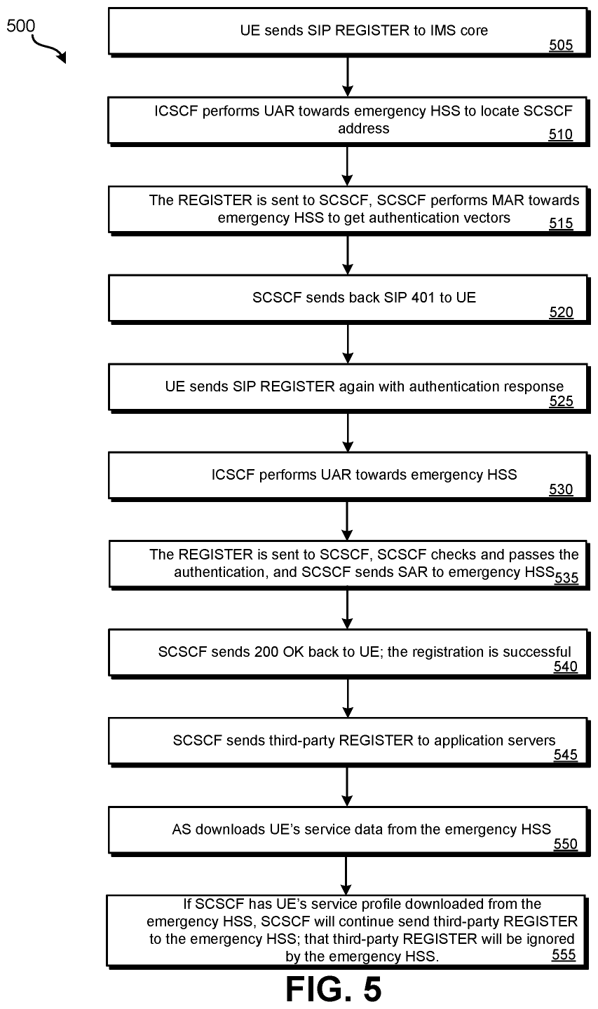

FIG. 5 illustrates an embodiment of a method 500 for registration call flow when the emergency HSS 235 is used, in accordance with embodiments according to the present disclosure. As indicated by block 505, UE may send a SIP REGISTER communication to the SBC 210 of the IMS core. As indicated by block 510, the ICSCF 220 may perform UAR and send a UAR message towards the HSS 215 to location the SCSCF 220 address. As indicated by block 515, the REGISTER message may be sent to the SCSCF 220, and the SCSCF may perform MAR and send an MAR message towards the HSS 215 to get authentication vectors. As indicated by block 520, the SCSCF 220 may send back the SIP 501 message the UE.

As indicated by block 525, the UE may send a SIP REGISTER message again with an authentication response. As indicated by block 530, the ICSCF 220 may perform UAR towards the emergency HSS 235. As indicated by block 535, the REGISTER message may be sent to the SCSCF 220. The SCSCF 220 may check and pass the authentication. The SCSCF 220 may send an SAR message to the emergency HSS 235. As indicated by block 540, the SCSCF 215 may send a SIP 200 (OK) response back to the UE, and the registration may be successful.

As indicated by block 545, the SCSCF 220 may send a third-party REGISTER message to the AS 225. As indicated by block 550, the AS 225 may download the UE's service data from the emergency HSS 235. As indicated by block 555, if the SCSCF 220 has the UE's service profile downloaded from the regular HSS 215, the SCSCF 220 may continue sending third-party REGISTER to the emergency HSS 235. That third-party REGISTER may be ignored by the emergency HSS 235. Otherwise, the SCSCF 220 would not send third-party REGISTER to the emergency HSS 235 since the emergency HSS 235 does not include itself as an application server in the UE's service profile.

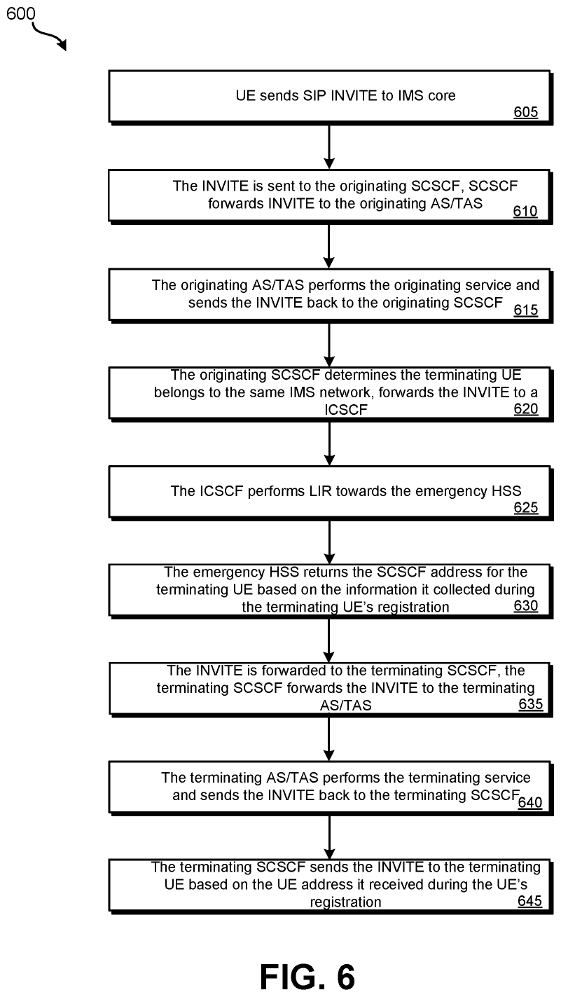

FIG. 6 illustrates an embodiment of a method 600 for an in-network voice call when the emergency HSS 235 is used, in accordance with embodiments according to the present disclosure. As indicated by block 605, UE may send a SIP INVITE communication to the SBC 210 of the IMS core. As indicated by block 610, the INVITE may be sent to the originating SCSCF 220, and the SCSCF 220 may forward the INVITE to the originating AS/TAS 225. As indicated by block 615, the originating AS/TAS 225 may perform the originating service and may send the INVITE back to the originating SCSCF 220. As indicated by block 620, the originating SCSCF 220 may determine the terminating UE belongs to the same IMS network and may forward the INVITE to a ICSCF 220.

As indicated by block 625, the ICSCF 220 may perform location-information-request (LIR) and send an LIR message towards the emergency HSS 235. As indicated by block 630, the emergency HSS 235 may return the SCSCF 220 address for the terminating UE based on the information it collected during the terminating UE's registration. As indicated by block 635, the INVITE may be forwarded to the terminating SCSCF 220, and the terminating SCSCF 220 may forward the INVITE to the terminating AS/TAS 225. As indicated by block 640, the terminating AS/TAS 225 may perform the terminating service and may send the INVITE back to the terminating SCSCF 220. As indicated by block 645, the terminating SCSCF 220 may send the INVITE to the terminating UE based on the UE address it received during the UE's registration.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations may be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed:

1. A cellular network system to facilitate continuation of voice services in an event of a failure in a wireless network, the cellular network comprising:
a cellular network core, wherein the cellular network comprises one or more servers; and
an emergency server, wherein the emergency server is configured to:
during non-emergency operations of the cellular network core:
collect subscriber mapping data, wherein the subscriber mapping data corresponds to subscriber phone numbers and international mobile subscriber identities (IMSIs) for particular user equipment (UE); and
store the subscriber mapping data in storage, wherein the storage is not shared with the cellular network core; and
during an emergency mode, use a mapping of the subscriber phone numbers and/or the IMSIs for the particular UE to facilitate completion of one or more voice calls.

2. The cellular network system to facilitate continuation of voice services in an event of a failure in a wireless network as recited in claim 1, where the cellular network core is configured to send subscriber data to the emergency server, wherein the subscriber data corresponds to UE registrations during the non-emergency operations of the cellular network core.

3. The cellular network system to facilitate continuation of voice services in an event of a failure in a wireless network as recited in claim 1, where the emergency server is further configured to update the subscriber mapping data as subscriber changes are made.

4. The cellular network system to facilitate continuation of voice services in an event of a failure in a wireless network as recited in claim 1, wherein the one or more servers comprise a home subscriber server (HSS).

5. The cellular network system to facilitate continuation of voice services in an event of a failure in a wireless network as recited in claim 4, wherein the emergency server corresponds to a standalone server that functions as an application server during normal operation mode and functions as a HSS during an emergency operation mode.

6. The cellular network system to facilitate continuation of voice services in an event of a failure in a wireless network as recited in claim 4, where the cellular network core is configured to use the HSS during the non-emergency operations and, in the emergency mode, the cellular network core reconfigures to use the emergency server to obtain the subscriber mapping data, the subscriber phone numbers, and/or the IMSIs for the particular UE, wherein the cellular network core uses the subscriber mapping data, the subscriber phone numbers, and/or the IMSIs for the particular UE to complete the one or more voice calls.

7. The cellular network system to facilitate continuation of voice services in an event of a failure in a wireless network as recited in claim 6, where the cellular network core transitions to the emergency mode when a database of the cellular network core is detected as having become corrupted.

8. The cellular network system to facilitate continuation of voice services in an event of a failure in a wireless network as recited in claim 1, wherein the cellular network core corresponds to an IP Multimedia Subsystem (IMS) core.

9. The cellular network system to facilitate continuation of voice services in an event of a failure in a wireless network as recited in claim 8, wherein the IMS core comprises a session border controller (SBC) and a call session control function (CSCF).

10. The cellular network system to facilitate continuation of voice services in an event of a failure in a wireless network as recited in claim 1, wherein the IMS core further comprises an application server (AS).

11. The cellular network system to facilitate continuation of voice services in an event of a failure in a wireless network as recited in claim 1, wherein the emergency server operates independently from the one or more servers.

12. The cellular network system to facilitate continuation of voice services in an event of a failure in a wireless network as recited in claim 11, wherein the emergency server is physically remote from the one or more servers.

13. A method to facilitate continuation of voice services in an event of a failure in a wireless network, the method comprising:
facilitating operating of a cellular network core in a non-emergency mode, wherein the cellular network comprises one or more servers;
during non-emergency operations of the cellular network core, collecting, by an emergency server, subscriber mapping data, wherein the subscriber mapping data corresponds to subscriber phone numbers and international mobile subscriber identities (IMSIs) for particular user equipment (UE);
during the non-emergency operations of the cellular network core, storing, by the emergency server, the subscriber mapping data in storage, wherein the storage is not shared with the cellular network core; and
during an emergency mode, using, by the emergency server, a mapping of the subscriber phone numbers and/or the IMSIs for the particular UE to facilitate completion of one or more voice calls.

14. The method to facilitate continuation of voice services in an event of a failure in a wireless network as recited in claim 13, the method further comprising sending, by the cellular network core, subscriber data to the emergency server, wherein the subscriber data corresponds to UE registrations during the non-emergency operations of the cellular network core.

15. The method to facilitate continuation of voice services in an event of a failure in a wireless network as recited in claim 13, the method further comprising updating, by the emergency server, the subscriber mapping data as subscriber changes are made.

16. The method to facilitate continuation of voice services in an event of a failure in a wireless network as recited in claim 13, wherein the one or more servers comprise a home subscriber server (HSS).

17. The method to facilitate continuation of voice services in an event of a failure in a wireless network as recited in claim 16, wherein the emergency server corresponds to a standalone server that functions as an application server during normal operation mode and functions as a HSS during an emergency operation mode.

18. The method to facilitate continuation of voice services in an event of a failure in a wireless network as recited in claim 17, the method further comprising:
using, by the cellular network core, the HSS during the non-emergency operations; and
in the emergency mode, reconfiguring, by the cellular network core, to use the emergency server to obtain the subscriber mapping data, the subscriber phone numbers, and/or the IMSIs for the particular UE, wherein the cellular network core uses the subscriber mapping data, the subscriber phone numbers, and/or the IMSIs for the particular UE to complete the one or more voice calls.

19. The method to facilitate continuation of voice services in an event of a failure in a wireless network as recited in claim 18, where the cellular network core transitions to the emergency mode when a database of the cellular network core is detected as having become corrupted.

20. One or more non-transitory, machine-readable media having machine-readable instructions thereon which, when executed by one or more processing devices, cause the one or more processing devices to perform operations to facilitate continuation of voice services in an event of a failure in a wireless network, the operations comprising:
facilitating operating of a cellular network core in a non-emergency mode, wherein the cellular network comprises one or more servers;
during non-emergency operations of the cellular network core, collecting, by an emergency server, subscriber mapping data, wherein the subscriber mapping data corresponds to subscriber phone numbers and international mobile subscriber identities (IMSIs) for particular user equipment (UE);
during the non-emergency operations of the cellular network core, storing, by the emergency server, the subscriber mapping data in storage, wherein the storage is not shared with the cellular network core; and
during an emergency mode, using, by the emergency server, a mapping of the subscriber phone numbers and/or the IMSIs for the particular UE to facilitate completion of one or more voice calls.
